(19) United States
(12) Patent Application Publication
(10) Pub. No.: US 2004/0021954 A1
(43) Pub. Date: Feb. 5, 2004

(54) Optical pickup objective lens

(76) Inventor: Yoichi Imanishi, Tokyo (JP)

Correspondence Address: VENABLE, BAETJER, HOWARD AND CIVILETTI, LLP, P.O. BOX 34385, WASHINGTON, DC, 20043-9998, US

(21) Appl. No.: 10/336,785

(22) Filed: Jan. 6, 2003

(30) Foreign Application Priority Data
Aug. 2, 2002 (JP) 2002-255,748

(51) Int. Cl. G02B 3/02; G02B 13/18

(52) U.S. Cl. 359/719

(57) ABSTRACT

An optical pickup objective lens capable of correcting the spherical aberration effectively for a DVD and a CD while achieving downsizing and reduction of the costs is provided. The objective lens is divided into two types of lens portions, a DVD/CD common lens portion and a DVD-specific lens portion, which are different in contour. The surfaces of the incident side and the outgoing side of both lens portions are aspherical in shape. The aspherical shape of the incident surface of the DVD/CD common lens portion differs from that of the DVD-specific lens portion, and the joint portion therebetween is discontinuous. Likewise, the aspherical shape of the outgoing surface of the DVD/CD common lens portion differs from that of the DVD-specific lens portion, and the joint portion therebetween is also discontinuous. Either one of the incident side and the outgoing side of the lens is formed with a diffracting plane for correcting an aberration for the DVD and the CD, which are different in thickness and operating wavelength, on the reference aspherical surface thereof.

### BACKGROUND OF THE INVENTION

1. Field of the Invention

The present invention relates to an objective lens used for optical pickup devices that are different in operating wavelength, NA (Numerical Aperture) or thickness of optical disk such as a DVD (Digital Versatile Disk) and a CD (Compact Disk).

2. Description of the Related Art

Several types of optical disks used in the optical pickup device are in practical use. Especially, in recent years, it has been required to provide a single objective lens capable of recording and reproducing those different types of optical disks such as the DVD and the CD, which are targets of the invention, for the purpose of downsizing and cost reduction.

However, since the standard specifications of the DVD (for example, the optical disk having a thickness of 0.6 mm, a recording and reproducing wavelength of 660 nm, and an NA of 0.6) and the CD (for example, the optical disk having a thickness of 1.2 mm, a recording and reproducing wavelength of 785 nm, and an NA of 0.45) are different, when an objective lens provided, for example, as a DVD-specific optical pickup device is used for a CD, a spherical aberration due to difference in the thickness of the optical disks and in the recording and reproducing wavelengths is generated.

Although such spherical aberration generated may be restrained by moving the objective lens toward the optical axis of the lens, such method of restraint is not sufficient for correcting the aberration and the beam spot, and leaves some affects.

In addition, when recording and reproducing the CD, a beam of light that passes through the lens portion of an NA not less than that of the CD and forms an image on the optical disk due to the difference of the effective diameters of luminous flux between the DVD and the CD caused as a result of the difference in NA between the DVD and the CD is not necessary for recording and reproducing the CD, and such beam of light largely affects on the aberration and the beam spot.

Although the beam of light passing through the portion of an NA not less than that of the CD can be removed or controlled by using an additional component in the optical pickup device, such increase in number of components of the optical pickup device is disadvantageous in terms of downsizing and cost reduction.

Providing specific suitable optical lenses for the DVD and the CD is the most effective solving means for removing the aberration or the unnecessary beam of light. However, it also results in increase in number of components as described above, which hinders downsizing and is disadvantageous in terms of cost reduction.

When a DVD-specific objective lens having a wavelength of 660 nm, which is an operating wavelength of the DVD, is provided, and then the optical lens is changed from the DVD having a thickness of 0.6 mm and an operational wavelength of 660 nm to the CD having a thickness of 1.2 mm and an operating wavelength of 785 nm, an excessive spherical aberration is generated due to the difference of the thickness and the operating wavelength between the DVD and the CD, which is too much to be corrected simply by moving the objective lens toward the optical axis of the lens.

### SUMMARY OF THE INVENTION

It is already described that a beam of light that passes through the lens portion of an NA not less than that of the CD and forms an image on the optical disk because of the difference in NA between the DVD and the CD is not necessary for recording and reproducing the CD, and significantly affects on the aberration and the beam spot.

Accordingly, it is an object of the invention to provide a single object lens for recording and reproducing the DVD and the CD taking downsizing and cost reduction into account, to correct a spherical aberration generated due to the difference in thickness and the operating wavelength between the DVD and the CD, and to correct a spherical aberration so that the light beam passing through the lens portion of an NA not less than that of the CD and forming an image on the optical disk because of the difference in the effective flux diameters of the DVD and the CD caused as a result of the difference in NA, which is not necessary for recording and reproducing the CD, does not affect on the image forming characteristic of the CD.

In order to achieve such object described above, the invention provides an optical pickup objective lens for conversing laser beams on the surfaces of the DVD and the CD for recording and reproducing data on the DVD and the CD that are different in thickness, including the DVD/CD common lens portion having an image forming characteristics for the DVD and the CD within a predetermined range of aperture, and the DVD-specific lens portion having a image forming characteristics only for the DVD outside the predetermined range of aperture, wherein the DVD/CD common lens portion and the DVD-specific lens portion are formed integrally, an incident side and an outgoing side of the integrally formed lens have such contour that the joint between the DVD/CD common lens portion and the DVD-specific lens portion is discontinuously formed and either one of the surfaces on the incident side and the outgoing side is provided with a diffracting plane.

The incident side of the DVD/CD common lens portion and the incident side of the DVD-specific lens portion of the invention may have different aspherical contours.

The outgoing side of the DVD/CD common lens portion and the outgoing side of the DVD-specific lens portion of the invention may have different aspherical contours.

The DVD/CD common lens portion and the DVD-specific lens portion of the invention may have the same paraxial curvature radius.

The DVD/CD common lens portion and the DVD-specific lens portion of the invention may have the same power of diffracting plane.

The DVD/CD common lens portion and the DVD-specific lens portion of the invention may have the same central thickness.

In other words, according to the invention, a lens is divided into two different types of lens portions, the DVD/CD common portion and the DVD-specific portion, and the respective lens portions have required characteristics for achieving the object described above.

The incident side and the outgoing side of the surface of this single objective lens including two types of lens portions combined with each other have discontinuous contours.

Provision of the diffracting plane on either one of the surfaces on the incident side and the outgoing side of the objective lens allows the aberrations of the DVD/CD common lens portion to be corrected respectively for the DVD and the CD, allows the aberration of the DVD-specific lens portion for the DVD to be corrected in the same manner as the aberration correction of the DVD/CD common lens portion for the DVD, and allows the aberration of the DVD-specific lens portion for the CD to be corrected so as not to affect on the on-CD image forming characteristic of the DVD/CD common lens portion.

By combining two types of lens portions having different characteristics and forming a single objective lens as described above, a lens having a continuous spherical aberration characteristics whereof the aberration is satisfactorily corrected for the DVD may be provided. While for the CD, a lens whereof the spherical aberration characteristics are discontinuous that prevents a beam of light passing through the DVD-specific lens portion and being unnecessary for the image forming characteristics of the CD from affecting on the image forming characteristics of the CD of the DVD/CD common lens portion may be provided.

Although the above-described lens includes the DVD/CD common lens portion and the DVD-specific lens portion having different characteristics respectively, the respective lens portions are preferably formed to have the same values in the paraxial curvature radius, the power of diffracting plane, and the thickness of the center of the lens in order to prevent occurrence of phase shift or wavelength dependency due to difference in image forming point of the DVD.

It is also preferable to form the contours of the DVD-specific lens portion to have an aspherical shape with diffracting planes that is different from, and discontinuous with respect to, the DVD/CD common lens portion to correct the aberration for the DVD and convert a beam of light passing the lens portion of an NA not less than that of the CD and hence giving affect on the image forming characteristics of the CD into a flared light beam.

### BRIEF DESCRIPTION OF THE DRAWINGS

FIG. 1A to FIG. 1C are drawings of an optical pickup objective lens according to the embodiment of the invention, in which FIG. 1A is a front view, FIG. 1B is a right side view, and FIG. 1C is a back view;

FIG. 2 is an explanatory drawing showing curvature radii and intervals of respective surfaces of the objective lens and a media in detail;

FIG. 3 is an explanatory drawing illustrating the contour of diffracting plane of the incident side or the outgoing side of the lens;

FIGS. 4(a) and 4(b) are graphs showing spherical aberrations of objective lens, wherein FIG. 4(a) shows the spherical aberrations for the DVD and FIG. 4(b) shows the spherical aberration for the CD according to the first embodiment; and

FIGS. 5(a) and 5(b) are graphs showing spherical aberrations of objective lens, wherein FIG. 5(a) shows the spherical aberrations for the DVD and FIG. 5(b) shows the spherical aberration for the CD according to the second embodiment.

### DESCRIPTION OF THE PREFERRED EMBODIMENTS

Referring now to the drawings, an embodiment of the invention will be described in detail.

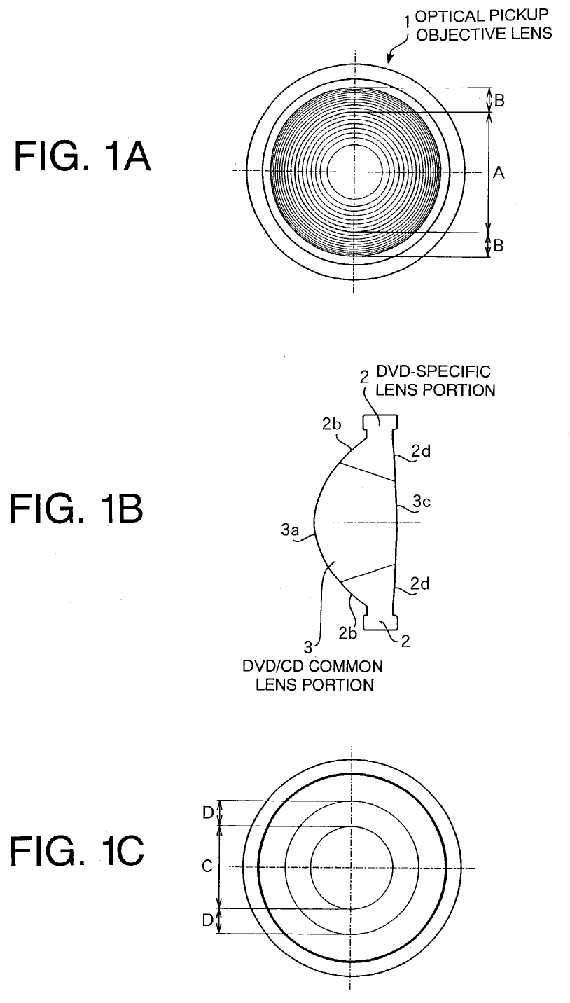

FIG. 1A to FIG. 1C are drawings of an optical pickup objective lens according to the embodiment of the invention, in which FIG. 1A is a front view, FIG. 1B is a right side view, and FIG. 1C is a back view.

An optical pickup objective lens 1 of the invention includes two different types of lens portions having different contours, a DVD/CD common lens portion 3 and a DVD-specific lens portion 2.

The incident surfaces and the outgoing surfaces of the DVD/CD common lens portion 3 and the DVD-specific lens portion 2 are aspherical. On the incident side, a predetermined range of aperture A corresponds to the DVD/CD common lens portion 3, and a portion B outside the predetermined range of aperture corresponds to the DVD-specific lens portion 2. On the outgoing side, a predetermined range of aperture C corresponds to the DVD/CD common lens portion 3, and a portion D outside the predetermined range of aperture corresponds to the DVD-specific lens portion 2. An aspherical shape of the incident surface 3a of the DVD/CD common lens portion 3 differs from that of an incident surface 2b of the DVD-specific lens portion 2, and the joint portion thereof is discontinuous. In the same manner, the aspherical shape of the outgoing surface 3c of the DVD/CD common lens portion 3 differs from that of the outgoing surface 2d of the DVD-specific lens portion 2, and the joint portion thereof is discontinuous.

In order to correct the aberrations of the DVD and the CD that are different in thickness and operating wavelength, a diffracting plane is formed on either one of the surfaces on the incident side and the outgoing side of the optical pickup objective lens 1 including the DVD/CD common lens portion 3 and the DVD-specific lens portion 2 on the reference aspherical surface described above.

The shape of the reference aspherical surface for the DVD/CD common lens portion 3 and the DVD-specific lens portion 2 is represented by the following equation.

$$Z ( Y ) = \frac{( 1 / r ) {Y}^{2}}{1 + \sqrt{( 1 - ( 1 + k ) {( 1 / r )}^{2} {Y}^{2} )}} + {\sum }_{N}^{} {A}_{N} {Y}^{N} \qquad ( 1 )$$

where r: paraxial curvature of radius, k: conical coefficient, Y: height from the optical axis, A_{N}: coefficient of aspherical surface (N≧2, even number), Z: axis in the direction of the optical axis, Y: axis perpendicular to the optical axis, and the direction of travel of a light is referred to as “normal” direction.

The shape of the diffracting plane may be obtained from a function expression of optical path difference and an expression representing the cutting amount since the reference aspherical surface shows a saw-tooth appearance after being provided with the diffracting planes.

The function expression of optical path difference and the expression representing the cutting amount for expressing the contour of the diffracting surface are as follows.

(Function Expression of Optical Path Difference)

$$φ ( Y ) = {\sum }_{N}^{} {B}_{N} {Y}^{N} \qquad ( 2 )$$

where Y: height from the optical axis, B_{N}: coefficient (N≧2, even number)

(Cutting Amount)

$$L = \frac{φ ( Y ) + i λ}{1 - n} \qquad ( 3 )$$

where λ: wavelength forming the contour, n: reference index of refraction of the lens, i=0, 1, 2. (integer value not less than zero), L represents a value with respect to the direction of the optical axis, and the direction of travel of the light is referred to as “normal” direction.

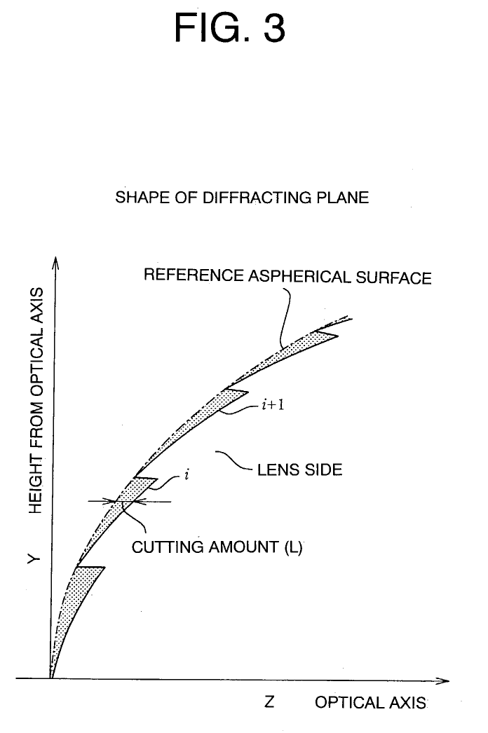

FIG. 3 is an explanatory drawing illustrating the contour of the diffracting plane of the incident surface or the outgoing surface of the lens.

The cutting amount L of the saw-tooth shape, which corresponds to the i^{th} diffracting plane from the optical axis, is an amount of cutting from the reference aspherical surface in the direction of the optical axis.

Provision of the diffracting plane on one or both of the incident surfaces and the outgoing surfaces of the two types of objective lenses allows the aberration and the beam spot of the DVD/CD common lens portion 3 to be corrected both for the DVD and the CD having difference thickness and the operating wavelength to the level allowable for recording and reproducing those disks.

By forming the DVD-specific lens portion 2 in the contour different from that of the DVD/CD common lens portion 3, for the DVD, the aberration and the beam spot is corrected to the level allowable for recording and reproducing the DVD, while for the CD being different in thickness and in operating wavelength, a beam of light giving affects on the image forming characteristics of the CD is converted into a flared light beam taking the characteristic of the optical pickup device into consideration.

Providing the same value of the paraxial curvature of radius, the power of diffracting plane and the thickness of the center of the lens on the optical axis to two types of objective lenses, the DVD/CD common lens portion 2 and the DVD-specific lens portion 3 allows the phase shift occurred between the DVD/CD common lens portion 3 and the DVD-specific lens portion 2 being different in contour, or variations in aberration due to difference of the wavelength between these lens portions to be restrained.

In this manner, by combining two types of objective lenses requiring different extent of aberration correction into a single objective lens, an optical pickup objective lens capable of recording and reproducing both of the DVD and the CD being different in operating wavelength, NA, and thickness.

The first embodiment and the second embodiment will be described below.

(First Embodiment)

The first embodiment presents an example in which reproduction is enabled for the DVD (NA=0.6), and the CD (NA=0.45).

The appearance of this objective lens is such that the lens is divided into two types of lens portions, the DVD/CD common lens portion and the DVD-specific lens portion on the incident side and the outgoing side, and the diffracting plane is formed on the surface on the incident side as shown in FIG. 1.

The specification of the objective lens is shown in Table 1, and the construction of the reference lens having the diffracting plane is shown in Table 2. Table 3 shows the aspherical shape of the lens, which is a reference surface of the lens divided into the DVD/CD common lens portion and the DVD-specific lens portion being different in characteristics according to the specification shown in Table 1 and construction shown in Table 2. Table 4 shows functions of optical path difference required for providing the contour of the diffracting plane.

In Table 1, λ1 and f1 represent the wavelength and the focal distance of the DVD, and λ2 and f2 represent the wavelength and the focal distance of the CD respectively. In Table 2, the surface numbers 1 and 2 represent the incident surface and the outgoing surface of the objective lens, respectively, and the surface numbers 3 and 4 represent the front and rear surfaces of the DVD or the CD media.

The reference numerals d1 and n1 represent the surface interval and the index of refraction in the case where the DVD media is used, and the reference numerals d2 and n2 represent the surface interval and the index of refraction in the case where the CD media is used, respectively.

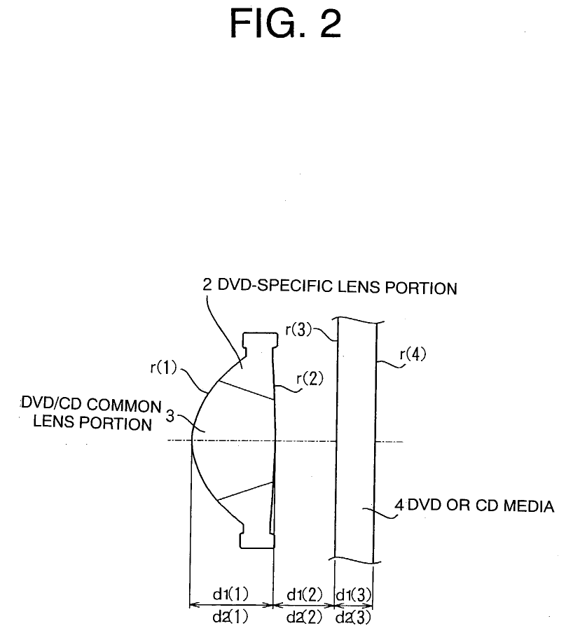

FIG. 2 shows the curvature radii and the intervals of the respective surfaces of the objective lens and the media in detail. The numeral values of the curvature radius shown in the column r at the positions corresponding to the surface numbers 1, 2, 3 and 4 in Table 2 are the curvature radius r(1) of the incident surface, the curvature radius r(2) of the outgoing surface, the curvature radii r(3) and r(4) of the front and rear of the DVD or the CD media, respectively, of the objective lens shown in FIG. 2.

The numeral values of the surface interval shown in the column d1 at the positions corresponding to the surface numbers 1, 2, and 3 in Table 2 are the thickness d1 (1) of the objective lens at the portion of the optical axis, the interval d1 (2) between the outgoing surface of the objective lens and the front surface of the DVD, and the thickness d1 (3) of the DVD media. The numerical values of the surface interval shown in the column d2 at the positions corresponding to the surface numbers 1, 2 and 3 in Table 2 are the thickness d2(1) of the objective lens at the position of the optical axis, the interval d2(2) between the outgoing surface of the objective lens and the front surface of the CD and the thickness d2(3) of the CD media.

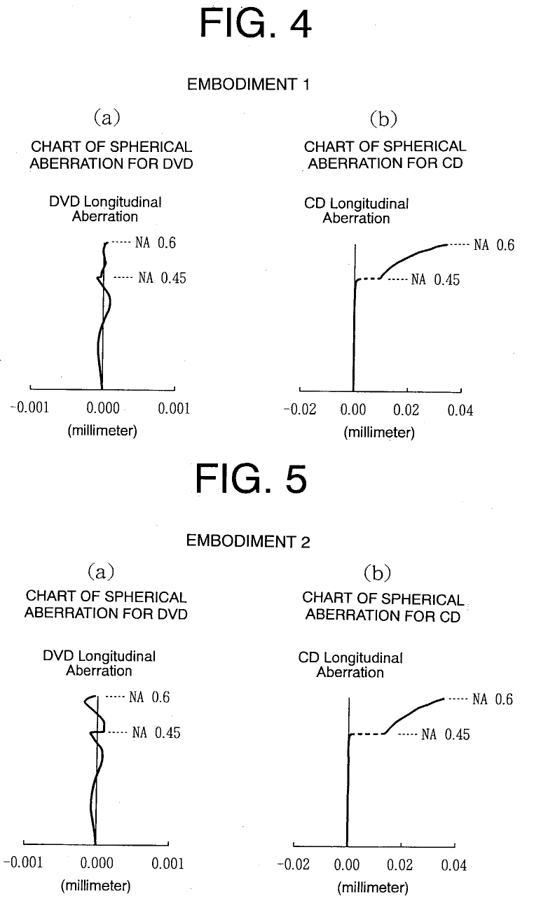

FIG. 4(a) and FIG. 4(b) are graphs showing spherical aberrations for the DVD and the CD in the first embodiment respectively. According to FIG. 4(a), the spherical aberration for the DVD is satisfactorily corrected to the lens portion whereof an NA is 0.6, though the contour is divided into two types of lens portions, the DVD/CD common lens portion and the DVD-specific lens portion.

On the other hand, the spherical aberration for the CD shown in FIG. 4(b) is satisfactorily corrected to the lens portion whereof an NA is 0.45, and portion ranging from 0.45 to 0.6 in NA, which corresponds to the DVD-specific lens portion is corrected so that a beam of light unnecessary for the reproduction of the CD is converted into a flared component to eliminate affects on the image forming characteristics and reproduction of the CD.

TABLE 1
(SPECIFICATIONS)

| | | |
|---|---|---|
| wave length | λ1 = 660 nm | λ2 = 785 nm |
| focal distance | f1 = 3.36 mm | f2 = 3.38 mm |
| No. of Apertures | NA1 = 0.6 | NA2 = 0.45 |

TABLE 2

| Surface No. | r | d1 | d2 | n1 | n2 |
|---|---|---|---|---|---|
| 1 | 2.104 | 2.200 | 2.200 | 1.54542 | 1.54213 |
| 2 | −8.965 | 1.740 | 1.374 | | |
| 3 | ∞ | 0.600 | 1.200 | 1.58000 | 1.57000 |
| 4 | ∞ | | | | |

TABLE 3
First Surface

| | |
|---|---|
| Common Element | Dedicated Element |
| (0 ≦ Y < 1.525) | (1.525 ≦ Y ≦ 2.02) |

| | | | |
|---|---|---|---|
| r1 | 2.104 | r1 | 2.104 |
| K | −0.627096 | K | −0.622007 |
| A4 | 2.57519E−04 | A4 | 5.78517E−07 |
| A6 | −1.56690E−04 | A6 | 8.74974E−08 |
| A8 | 3.94168E−05 | A8 | 1.46907E−08 |
| A10 | −4.78691E−06 | A10 | 3.22671E−09 |
| A12 | 2.86052E−07 | A12 | 4.68816E−10 |
| A14 | 5.36192E−07 | A14 | 7.29138E−11 |
| A16 | −9.89578E−08 | A16 | 4.98606E−12 |
| A18 | −2.92849E−08 | A18 | 9.43905E−13 |
| A20 | 7.27262E−09 | A20 | 1.43390E−12 |

Second Surface

| | |
|---|---|
| Common Element | Dedicated Element |
| (0 ≦ Y < 1.125) | (1.125 ≦ Y ≦ 1.635) |

| | | | |
|---|---|---|---|
| R1 | −8.965 | r1 | −8.965 |
| K | −18.520363 | k | −20.546796 |
| A4 | 1.42509E−02 | A4 | 1.04010E−02 |
| A6 | −3.89101E−03 | A6 | −1.95047E−03 |
| A8 | 7.55189E−04 | A8 | −1.52863E−04 |
| A10 | −3.80010E−05 | A10 | 7.87786E−05 |
| A12 | −3.41568E−05 | A12 | 1.70534E−05 |
| A14 | 5.16925E−06 | A14 | −4.60511E−06 |
| A16 | 2.07139E−06 | A16 | −2.64844E−06 |
| A18 | −7.20040E−07 | A18 | 8.77713E−07 |
| A20 | 6.66575E−08 | A20 | −7.17181E−08 |

TABLE 4
First Surface

| | |
|---|---|
| Common Element | Dedicated Element |
| (0 ≦ Y < 1.525) | (1.525 ≦ Y ≦ 2.02) |

| | | | |
|---|---|---|---|
| B4 | −1.17505E−03 | B4 | −9.69164E−04 |
| B6 | −1.83077E−04 | B6 | −5.12181E−05 |
| B8 | 1 .42334E−04 | B8 | −1.17856E−05 |
| B10 | −3.85641E−04 | B10 | 1.29973E−05 |
| B12 | 6.42340E−04 | B12 | −1.01866E−05 |
| B14 | −6.28211E−04 | B14 | 5.88495E−06 |
| B16 | 3.71848E−04 | B16 | −1.75541E−06 |
| B18 | −1.31078E−04 | B18 | 2.74985E−07 |
| B20 | 2.53227E−05 | B20 | −2.18450E−08 |
| B22 | −2.06350E−06 | B22 | 8.12960E−10 |

(Second Embodiment)

The second embodiment is characterized in that the extent of aberration of the DVD-specific lens portion is modified for the DVD (NA=0.6) and the CD (NA=0.45) as in the case of the first embodiment, and the amount of the spherical aberration for the CD, which is larger than in the first embodiment, is corrected to the level that an unnecessary beam of light is flared so as not to affect on the spherical aberration characteristics of the DVD.

The specification of the objective lens is shown in Table 5, and the construction of the reference lens having the diffracting surfaces is shown in Table 6, respectively. Table 7 shows the aspherical shape of the reference lens of the lens portion having the specification shown in Table 5 and the construction shown in Table 6, and divided into two lens portions, the DVD/CD common lens portion and the DVD-specific lens portion, which are different in characteristics. Table 8 shows functions of optical path difference required for providing the contour of the diffracting plane.

The definitions of the wavelength, the focal distance, the curvature radius, the interval in Tables 5, 6, 7 and 8 are the same as Table 1, 2, 3 and 4 in the first embodiment.

FIGS. 5(a) and FIG. 5(b) show the spherical aberrations of the DVD and the CD according to the second embodiment. According to FIG. 5(a), the spherical aberration for the DVD is satisfactorily corrected to the portion whereof an NA is 0.6 though the contour of the lens is divided into two types of lens portions, the DVD/CD common lens portion and the DVD-specific lens portion, as in the first embodiment.

The spherical aberration for the CD shown in FIG. 5(b) is satisfactorily corrected to the portion whereof an NA is 0.45, and the DVD-specific lens portion ranging from 0.45 to 0.6 in NA is corrected in such a manner that a beam of light unnecessary for the reproduction of the CD is flared so as not to affect on the image forming characteristics and reproduction of the CD as in the case of the first embodiment.

TABLE 5
(SPECIFICATIONS)

| | | |
|---|---|---|
| wave length | λ1 = 660 nm | λ2 = 785 nm |
| focal distance | f1 = 3.36 mm | f2 = 3.38 mm |
| No. of Apertures | NA1 = 0.6 | NA2 = 0.45 |

TABLE 6

| Surface No. | r | d1 | d2 | n1 | n2 |
|---|---|---|---|---|---|
| 1 | 2.104 | 2.200 | 2.200 | 1.54542 | 1.54213 |
| 2 | −8.965 | 1.740 | 1.374 | | |
| 3 | ∞ | 0.600 | 1.200 | 1.58000 | 1.57000 |
| 4 | ∞ | | | | |

TABLE 7
First Surface

| | |
|---|---|
| Common Element | Dedicated Element |
| (0 ≦ Y < 1.525) | (1.525 ≦ Y ≦ 2.02) |

| | | | |
|---|---|---|---|
| r1 | 2.104 | r1 | 2.104 |
| k | −0.627096 | K | −0.580514 |
| A4 | 2.57519E−04 | A4 | 1.19067E−06 |
| A6 | −1.56690E−04 | A6 | 4.04835E−08 |
| A8 | 3.94168E−05 | A8 | 8.60718E−08 |
| A10 | −4.78691E−06 | A10 | 1.90489E−08 |
| A12 | 2.86052E−07 | A12 | 1.33772E−08 |
| A14 | 5.36192E−07 | | |
| A16 | −9.89578E−08 | | |
| A18 | −2.92849E−08 | | |
| A20 | 7.27262E−09 | | |

Second Surface

| | |
|---|---|
| Common Element | Dedicated Element |
| (0 ≦ Y < 1.125) | (1.125 ≦ Y ≦ 1.635) |

| | | | |
|---|---|---|---|
| r1 | −8.965 | r1 | −8.965 |
| k | −18.520363 | K | −26.0 |
| A4 | 1.42509E−02 | A4 | 9.56849E−03 |
| A6 | −3.89101E−03 | AG | −1.40500E−03 |
| A8 | 7.55189E−04 | A8 | −1.79532E−04 |
| A10 | −3.80010E−05 | A10 | 8.14269E−05 |
| A12 | −3.41568E−05 | A12 | −7.69854E−06 |
| A14 | 5.16925E−06 | | |
| A16 | 2.07139E−06 | | |
| A18 | −7.20040E−07 | | |
| A20 | 6.66575E−08 | | |

TABLE 8
First Surface

| | |
|---|---|
| Common Element | Dedicated Element |
| (0 ≦ Y < 1.525) | (1.525 ≦ Y ≦ 2.02) |

| | | | |
|---|---|---|---|
| B4 | −1.17515E−03 | B4 | −6.13515E−04 |
| B6 | −1.83077E−04 | B6 | −1.18964E−04 |
| B8 | 1.42334E−04 | B8 | 2.93336E−05 |
| B10 | −3.85641E−04 | B10 | −8.99099E−06 |
| B12 | 6.42340E−04 | B12 | 2.27492E−06 |
| B14 | −6.28211E−04 | B14 | −2.96334E−07 |
| B16 | 3.71848E−04 | B16 | 6.38423E−08 |
| B18 | −1.31078E−04 | B18 | −1.34304E−08 |
| B20 | 2.53227E−05 | B20 | 1.56220E−09 |
| B22 | −2.06350E−06 | B22 | −7.51490E−11 |

As described thus far, according to the invention, the lens is divided into two types of lens portions, the DVD/CD common lens portion and the DVD-specific lens portion being different in characteristics, these two types lenses are different in contour for providing the required aberration characteristics respectively, and the diffracting plane is formed at least on any one of the incident surface and the outgoing surface, and these two types of lens portions are combined to form a single objective lens. Therefore, in comparison with the objective lens in the related art, an objective lens that is effective as a lens commonly used for the DVD and the CD, which are different in operating wavelength, NA, and thickness, may be achieved while reducing the size and the cost.

What is claimed is:

1. An optical pickup objective lens for conversing laser beams on the surfaces of a DVD and a CD for recording and reproducing data on the DVD and the CD that are different in thickness, comprising:
a DVD/CD common lens portion having an image forming characteristics for the DVD and the CD within a predetermined range of aperture; and
a DVD-specific lens portion having a image forming characteristics only for the DVD outside the predetermined range of aperture,
wherein the DVD/CD common lens portion and the DVD-specific lens portion are formed integrally, an incident side and an outgoing side of the integrally formed lens have such contour that the joint portion between the DVD/CD common lens portion and the DVD-specific lens portion are discontinuously formed and either one of the surfaces on the incident side and the outgoing side is provided with a diffracting plane.

2. An optical pickup objective lens according to claim 1, wherein the incident side of the DVD/CD common lens portion and the incident side of the DVD-specific lens portion have different aspherical contours.

3. An optical pickup objective lens according to claim 1, wherein the outgoing side of the DVD/CD common lens portion and the outgoing side of the DVD-specific lens portion have different aspherical contours.

4. An optical pickup objective lens according to claim 1, wherein the DVD/CD common lens portion and the DVD-specific lens portion may have the same paraxial curvature radius.

5. An optical pickup objective lens according to claim 1, wherein the DVD/CD common lens portion and the DVD-specific lens portion have the same power of diffracting plane.

6. An optical pickup objective lens according to claim 1, wherein the DVD/CD common lens portion and the DVD-specific lens portion have the same central thickness.
